(19) United States
(12) Patent Application Publication
(10) Pub. No.: US 2026/0133581 A1
(43) Pub. Date: May 14, 2026

(54) SYSTEMS AND METHODS FOR CONTROLLING AUTOMATED GUIDED VEHICLES

(71) Applicant: ZHEJIANG HUARAY TECHNOLOGY CO., LTD., Hangzhou (CN)

(72) Inventors: Jiangtao CHEN, Hangzhou (CN); Wei LU, Hangzhou (CN); Yidong JIN, Hangzhou (CN); Zhen YAO, Hangzhou (CN)

(73) Assignee: ZHEJIANG HUARAY TECHNOLOGY CO., LTD., Hangzhou (CN)

(21) Appl. No.: 19/443,060

(22) Filed: Jan. 8, 2026

Related U.S. Application Data
(63) Continuation of application No. PCT/CN2024/101202, filed on Jun. 25, 2024.

(30) Foreign Application Priority Data
Aug. 2, 2023 (CN) 202310964387.1

(51) Int. Cl. G05D 1/246; G01C 21/00; G05D 103/00

(52) U.S. Cl. CPC G05D 1/246; G01C 21/3859; G05D 2103/00

(57) ABSTRACT

A method for controlling an automated guided vehicle (AGV) includes: determining an environment graph of the AGV by preprocessing an AGV scene map; in response to the environment graph of the AGV not satisfying a first preset condition, performing at least one environmental adjustment, wherein each environmental adjustment includes: determining an adjustment of the environment graph by performing a path planning for the AGV, wherein a portion of constraints of the environment graph is ignored in the path planning, performing a troubleshooting operation by controlling a transport system based on the adjustment of the environment graph, and updating the environment graph based on a result of the troubleshooting operation; and in response to the environment graph satisfying the first preset condition, determining a driving path of the AGV, and controlling the AGV to drive along the driving path.

### CROSS-REFERENCE TO RELATED APPLICATIONS

This application is a continuation of International Patent Application No. PCT/CN2024/101202, filed on Jun. 25, 2024, which claims the priority of Chinese Patent Application No. 202310964387.1, filed on Aug. 2, 2023, the contents of each of which are hereby incorporated by reference.

### TECHNICAL FIELD

The disclosure generally relates to automated guided vehicles (AGVs), and more particularly relates to systems and methods for controlling automated guided vehicles.

### BACKGROUND

The AGV is an automatic guided handling device that can achieve autonomous handling in work scenarios. In existing AGV work scenarios, such as a warehouse, there are generally multiple AGVs. In order to schedule and arrange the orderly work of multiple AGVs, a transport system may be equipped. At the same time, a corresponding environment graph may be configured for the scenario. The multiple AGVs may be planned based on constraints of each node and edge in the environment graph to transport loads to a designated location.

During the planning process, due to the constraints on certain nodes or edges in the environment graph, the AGV may be unable to select that nodes or edges as a path, resulting in planning failure. As the scale of the environment graph expands, on-site personnel may spend a lot of time investigating the reasons for failure, seriously affecting work efficiency and increasing costs.

Thus, it is desired to provide systems and methods for controlling automated guided vehicles with improved work efficiency.

### SUMMARY

According to a first aspect of the present disclosure, a method for controlling an automated guided vehicle (AGV) is provided. The method may be implemented on at least one computing device, each of which may include at least one processor and a storage device. The method may include determining an environment graph of the AGV by preprocessing an AGV scene map, the AGV scene map including multiple nodes and multiple edges connected to the multiple nodes, wherein an attribute of each node in the environment graph includes a first constraint on passability of the node and a second constraint on an angle at which the AGV or a load of the AGV is allowed to pass, and an attribute of each edge in the environment graph includes a third constraint on connectivity of the edge, a fourth constraint on passability of the edge, and a fifth constraint on an angle at which the AGV or the load of the AGV is allowed to pass; and in response to the environment graph of the AGV not satisfying a first preset condition, performing at least one environmental adjustment, wherein each environmental adjustment includes: determining an adjustment of the environment graph by performing a path planning for the AGV, wherein a portion of constraints of the environment graph is ignored in the path planning, performing a troubleshooting operation by controlling a transport system based on the adjustment of the environment graph, and updating the environment graph based on a result of the troubleshooting operation; and in response to the environment graph satisfying the first preset condition, determining a driving path of the AGV based on the environment graph, and controlling the AGV to drive along the driving path.

In some embodiments, the each environmental adjustment further includes: performing a preliminary path planning for the AGV based on the environment graph, wherein constraints on interfering AGVs and interfering loads in the environment graph are ignored; and in response to a failure of the preliminary path planning, determining a first node set by recording nodes searched in the preliminary path planning.

In some embodiments, the determining the adjustment of the environment graph by performing the path planning for the AGV includes: in response to receiving a user input instruction, determining a second node set based on the user input instruction; determining a first target node based on the first node set and the second node set; and determining the adjustment of the environment graph based on the first target node.

In some embodiments, the determining the adjustment of the environment graph by performing the path planning for the AGV includes: in response to not receiving a user input instruction, performing a first path planning for the AGV, wherein constraints on passability and angles of the multiple nodes and the multiple edges in the environment graph are ignored in the first path planning; in response to a success of the first path planning, determining a second node set based on the first path planning, determining a first target node based on the first node set and the second node set, and determining the adjustment of the environment graph based on the first target node; and in response to a failure of the first path planning, determining a boundary node based on nodes searched in the first path planning, and determining the adjustment of the environment graph based on the boundary node.

In some embodiments, the determining the boundary node based on the nodes searched in the first path planning includes: obtaining an adjacency matrix of the multiple nodes in the environment graph; and determining the boundary node based on the adjacency matrix and the nodes searched in the first path planning.

In some embodiments, the determining the first target node based on the first node set and the second node set includes: determining a node set similarity based on the first node set and the second node set; and in response to the node set similarity not being 1, determining the first target node by a first preset algorithm.

In some embodiments, the determining the adjustment of the environment graph based on the first target node includes: determining an evaluation node based on the first target node; in response to the evaluation node or an evaluation edge connecting to the evaluation node and the first target node not meeting a passability requirement, adjusting the first constraint on passability of the evaluation node or the fourth constraint on passability of the evaluation edge; and in response to the evaluation node and the evaluation edge connecting to the evaluation node and the first target node meeting the passability requirement, performing a second path planning for the AGV, wherein constraints on passability of the multiple nodes and the multiple edges include constraints on load, the constraints on load is ignored in the second path planning, determining a third node set by recording nodes searched in the second path planning, determining a second target node based on the third node set and the first node set, and determining the adjustment of the environment graph based on the second target node.

In some embodiments, the determining the adjustment of the environment graph based on the second target node includes: determining a rotation evaluation node based on the second target node; and determining the adjustment of the environment graph based on the rotation evaluation node.

In some embodiments, the determining the adjustment of the environment graph based on the first target node includes: determining an evaluation node based on the first target node; in response to the evaluation node or an evaluation edge connecting to the evaluation node and the first target node not meeting a passability requirement, adjusting the first constraint on passability of the evaluation node or the fourth constraint on passability of the evaluation edge; and in response to the evaluation node and the evaluation edge connecting the evaluation node and the first target node meeting the passability requirement, performing a third path planning for the AGV, wherein the constraints on passability of the multiple nodes and the multiple edges include constraints on equipment, the constraints on equipment is ignored in the third path planning, determining a fourth node set by recording nodes searched in the third path planning, determining a third target node based on the fourth node set and the first node set, and determining the adjustment of the environment graph based on the third target node.

In some embodiments, the determining the adjustment of the environment graph based on the third target node includes: determining a rotation evaluation node based on the third target node; and determining the adjustment of the environment graph based on the rotation evaluation node.

In some embodiments, the adjustment is related to one or more equipment parameters of the AGV, and the determining the adjustment of the environment graph based on the rotation evaluation node includes: determining the adjustment of the environment graph based on the rotation evaluation node and the one or more equipment parameters of the AGV.

In some embodiments, the determining the adjustment of the environment graph based on the rotation evaluation node and the one or more equipment parameters of the AGV includes: determining a rotation angle feature based on the one or more equipment parameters of the AGV; and determining the adjustment of the environment graph based on the rotation evaluation node and the rotation angle feature.

According to a second aspect of the present disclosure, a system is provided. The system may include at least one storage device storing executable instructions for controlling an automated guided vehicle (AGV), and at least one processor in communication with the at least one storage device. When executing the executable instructions, the at least one processor may cause the system to perform one or more of the following operations. The operations may include: determining an environment graph of the AGV by preprocessing an AGV scene map, the AGV scene map including multiple nodes and multiple edges connected to the multiple nodes, wherein an attribute of each node in the environment graph includes a first constraint on passability of the node and a second constraint on an angle at which the AGV or a load of the AGV is allowed to pass, and an attribute of each edge in the environment graph includes a third constraint on connectivity of the edge, a fourth constraint on passability of the edge, and a fifth constraint on an angle at which the AGV or the load of the AGV is allowed to pass; and in response to the environment graph of the AGV not satisfying a first preset condition, performing at least one environmental adjustment, wherein each environmental adjustment includes: determining an adjustment of the environment graph by performing a path planning for the AGV, wherein a portion of constraints of the environment graph is ignored in the path planning, performing a troubleshooting operation by controlling a transport system based on the adjustment of the environment graph, and updating the environment graph based on a result of the troubleshooting operation; and in response to the environment graph satisfying the first preset condition, determining a driving path of the AGV based on the environment graph, and controlling the AGV to drive along the driving path.

According to a third aspect of the present disclosure, a non-transitory computer-readable medium storing at least one set of instructions for controlling an automated guided vehicle (AGV) is provided. When executed by at least one processor, the at least one set of instructions may direct the at least one processor to perform a method. The method may include: determining an environment graph of the AGV by preprocessing an AGV scene map, the AGV scene map including multiple nodes and multiple edges connected to the multiple nodes, wherein an attribute of each node in the environment graph includes a first constraint on passability of the node and a second constraint on an angle at which the AGV or a load of the AGV is allowed to pass, and an attribute of each edge in the environment graph includes a third constraint on connectivity of the edge, a fourth constraint on passability of the edge, and a fifth constraint on an angle at which the AGV or the load of the AGV is allowed to pass; and in response to the environment graph of the AGV not satisfying a first preset condition, performing at least one environmental adjustment, wherein each environmental adjustment includes: determining an adjustment of the environment graph by performing a path planning for the AGV, wherein a portion of constraints of the environment graph is ignored in the path planning, performing a troubleshooting operation by controlling a transport system based on the adjustment of the environment graph, and updating the environment graph based on a result of the troubleshooting operation; and in response to the environment graph satisfying the first preset condition, determining a driving path of the AGV based on the environment graph, and controlling the AGV to drive along the driving path.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. The drawings are not scaled. These embodiments are non-limiting exemplary embodiments, in which like reference numerals represent similar structures throughout the several views of the drawings, and wherein:

FIG. 1 is a schematic diagram illustrating an exemplary transport system according to some embodiments of the present disclosure;

FIG. 2 is a block diagram illustrating an exemplary processing device according to some embodiments of the present disclosure;

FIG. 3 is a flowchart illustrating an exemplary process for controlling an automated guided vehicle according to some embodiments of the present disclosure;

FIG. 4A is a flowchart illustrating an exemplary process for determining an adjustment of an environment graph according to some embodiments of the present disclosure;

FIG. 4B is a schematic diagram illustrating an exemplary environment graph according to some embodiments of the present disclosure;

FIG. 4C is a schematic diagram illustrating an exemplary updated environment graph according to some embodiments of the present disclosure;

FIG. 5 is a flowchart illustrating an exemplary process for determining an adjustment of an environment graph according to some embodiments of the present disclosure; and

FIG. 6 is a schematic diagram illustrating a portion of an exemplary environment graph according to some embodiments of the present disclosure.

### DETAILED DESCRIPTION

The following description is presented to enable any person skilled in the art to make and use the present disclosure and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including” when used in this disclosure, specify the presence of stated features, integers, steps, operations, elements, and/or components, but do not preclude the presence or addition of one or more other features, integers, steps, operations, elements, components, and/or groups thereof.

It will be understood that, although the terms “first,” “second,” “third,” etc., may be used herein to describe various elements, these elements should not be limited by these terms. These terms are only used to distinguish one element from another. For example, a first element could be termed a second element, and, similarly, a second element could be termed a first element, without departing from the scope of exemplary embodiments of the present disclosure.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments in the present disclosure. It is to be expressly understood, the operations of the flowchart may be implemented not in order. Conversely, the operations may be implemented in an inverted order, or simultaneously. Moreover, one or more other operations may be added to the flowcharts. One or more operations may be removed from the flowcharts.

Provided herein are systems and methods for controlling an automated guided vehicle (AGV). For example, the method may include determining an environment graph of the AGV by preprocessing an AGV scene map. The AGV scene map may include multiple nodes and multiple edges connected to the multiple nodes. An attribute of each node may include a first constraint on passability of the node and a second constraint on an angle at which the AGV or a load of the AGV is allowed to pass. An attribute of each edge may include a third constraint on connectivity of the edge, a fourth constraint on passability of the edge, and a fifth constraint on an angle at which the AGV or the load of the AGV is allowed to pass. The method may further include in response to the environment graph of the AGV not satisfying a first preset condition, performing at least one environmental adjustment. In some embodiments, each environmental adjustment may include determining an adjustment of the environment graph by performing a path planning for the AGV, wherein a portion of constraints of the environment graph is ignored in the path planning, performing a troubleshooting operation by controlling a transport system based on the adjustment of the environment graph, and updating the environment graph based on a result of the troubleshooting operation. The method may also include in response to the environment graph satisfying the first preset condition, determining a driving path of the AGV based on the environment graph and controlling the AGV to drive along the driving path.

According to some embodiments of the present disclosure, the AGV scene map is preprocessed taking into account the actual situations of the transportation scenario of the AGV and load information of the AGV. During the preprocessing process, attributes of the multiple nodes and multiple edges are considered. When these attributes cause the nodes or edges to be unavailable and the path planning of the AGV fails (for example, not satisfying the first preset condition), the at least one processor can perform at least one environmental adjustment to backtrack to find these nodes and edges, so as to modify task information (e.g., changing a starting point or an ending point) or the attributes of nodes and edges without affecting the connectivity of the AGV scene map.

Moreover, during the controlling process of the AGV, when determining the adjustment of the environment graph, by ignoring a portion of constraints of the environment graph to performing the path planning for the AGV, the reason why the environment graph of the AGV does not satisfy the first preset condition can be determined intelligently and quickly, thereby improving the efficiency of troubleshooting operations and saving labor costs.

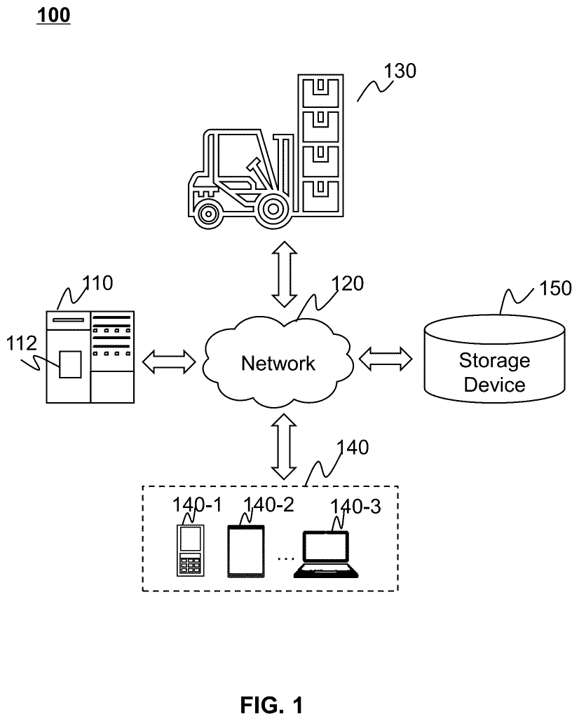

FIG. 1 is a schematic diagram illustrating an exemplary transport system according to some embodiments of the present disclosure. As illustrated in FIG. 1, the transport system 100 may include a server 110, a network 120, an automated guided vehicle (AGV) 130, a terminal device 140, and a storage device 150.

The server 110 may be a single server or a server group. The server group may be centralized or distributed (e.g., the server 110 may be a distributed system). In some embodiments, the server 110 may be local or remote. In some embodiments, the server 110 may be implemented on a cloud platform. In some embodiments, the server 110 may be implemented on a computing device having a processor and a memory.

The memory may be configured to sore one or more programs and/or instructions to perform exemplary methods described in the present disclosure. The processor may be an integrated circuit chip with signal processing capabilities. In some embodiments, the processor may include one or more hardware processors, such as a microcontroller, a microprocessor, a reduced instruction set computer (RISC), an application-specific integrated circuits (ASICs), an application-specific instruction-set processor (ASIP), a central processing unit (CPU), a graphics processing unit (GPU), a physics processing unit (PPU), a microcontroller unit, a digital signal processor (DSP), a field-programmable gate array (FPGA), an advanced RISC machine (ARM), a programmable logic device (PLD), any circuit or processor capable of executing one or more functions, or the like, or any combinations thereof.

In some embodiments, the server 110 may include a processing device 112. The processing device 112 may process data and/or information relating to controlling the AGV to perform one or more functions described in the present disclosure. In some embodiments, the processing device 112 may include one or more processing engines (e.g., single-core processing engine(s) or multi-core processor(s)).

In some embodiment, the sever 110 may be unnecessary and all or part of the functions of the server 110 may be implemented by other components (e.g., the AGV 130, the terminal device 140) of the transport system 100. For example, the processing device 112 may be integrated into the AGV 130 or the terminal device 140 and the functions of the processing device 112 may be implemented by the AGV 130 or the terminal device 140.

The network 120 may facilitate the exchange of information and/or data for the transport system 100. In some embodiments, one or more components (e.g., the server 110, the AGV 130, the terminal device 140, or the storage device 150) of the transport system 100 may transmit information and/or data to one or more other components of the transport system 100 via the network 120. In some embodiments, the network 120 may be any type of wired or wireless network, or combination thereof.

The AGV 130 may be configured for autonomous cargo transportation. The transport system 100 may control the AGV 130 to transport a load (e.g., goods) from a starting point to an ending point according to a driving path.

The terminal device 140 may be configured to receive information and/or data from the server 110, the AGV 130, and/or the storage device 150 via the network 120. For example, the terminal device 140 may receive an environment graph from the server 110. In some embodiments, the terminal device 140 may provide a user interface via which a user may view information and/or input data and/or instructions to the transport system 100. For example, the user may view, via the user interface, information associated with the AGV 130. As another example, the user may input, via the user interface, a user input instruction to set a path of the AGV 130. In some embodiments, the terminal device 140 may include a mobile device 140-1, a tablet computer 140-2, a laptop computer 140-3, or the like, or any combination thereof. In some embodiments, the terminal device 140 may include a display that can display information in a human-readable form, such as text, image, audio, video, graph, animation, or the like, or any combination thereof.

The storage device 150 may be configured to store data and/or instructions. The data and/or instructions may be obtained from, for example, the server 110, the AGV 130, and/or any other component of the transport system 100. In some embodiments, the storage device 150 may store data and/or instructions that the server 110 may execute or use to perform exemplary methods described in the present disclosure. In some embodiments, the storage device 150 may include a mass storage device, a removable storage device, a volatile read-and-write memory, a read-only memory (ROM), or the like, or any combination thereof. In some embodiments, the storage device 150 may be implemented on a cloud platform.

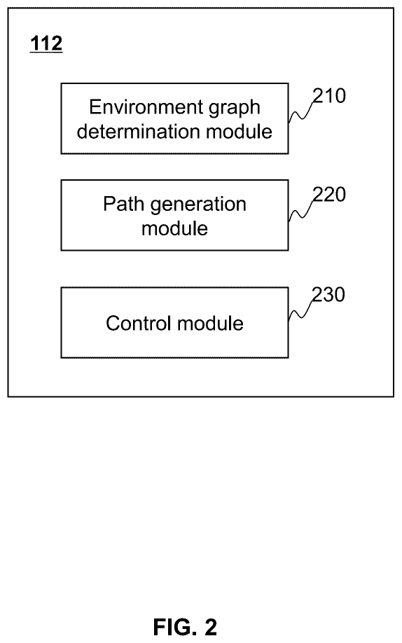

FIG. 2 is a block diagram illustrating an exemplary processing device according to some embodiments of the present disclosure. As illustrated in FIG. 2, the processing device 112 may include an environment graph determination module 210, a path generation module 220, and a control module 230.

The environment graph determination module 210 may be configured to determine an environment graph of an automated guided vehicle (AGV) by preprocessing an AGV scene map.

The path generation module 220 may be configured to determine whether the environment graph of the AGV satisfies a first preset condition. In response to a determination that the environment graph does not satisfy the first preset condition, the path generation module 220 may determine an adjustment of the environment graph by performing a path planning for the AGV. The path generation module 220 may perform a troubleshooting operation by controlling the transport system (e.g., the transport system 100) based on the adjustment of the environment graph. The path generation module 220 may update the environment graph based on a result of the troubleshooting operation. In response to a determination that the environment graph satisfies the first preset condition, the path generation module 220 may determine a driving path of the AGV based on the environment graph.

The control module 230 may be configured to control the AGV to drive along the driving path.

The modules in the processing device 112 may be connected to or communicate with each other via a wired connection or a wireless connection. Two or more of the modules may be combined as a single module, and any one of the modules may be divided into two or more units.

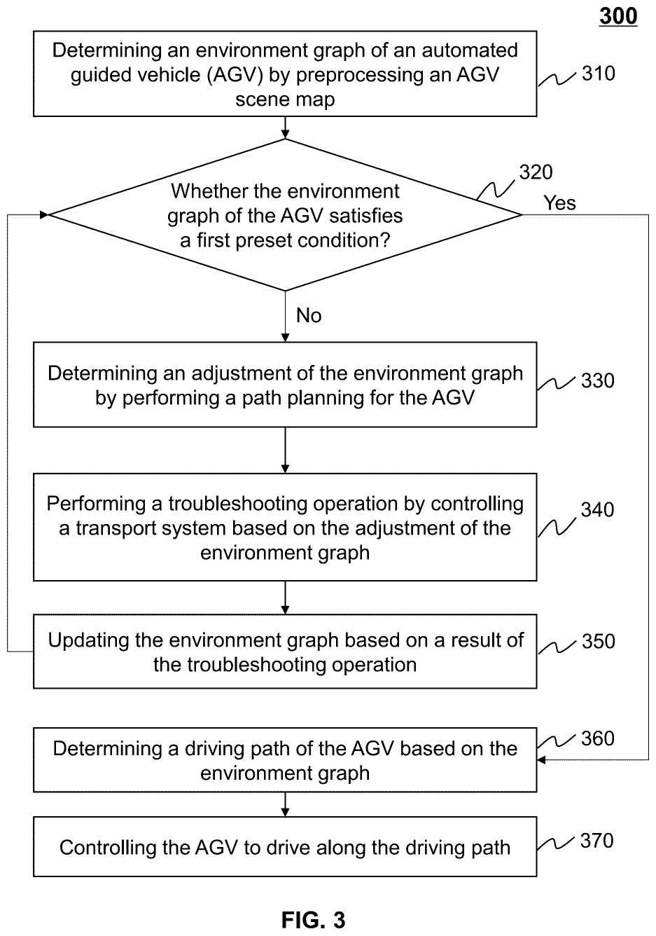

FIG. 3 is a flowchart illustrating an exemplary process for controlling an automated guided vehicle according to some embodiments of the present disclosure. In some embodiments, process 300 may be executed by the transport system 100. For example, process 300 may be implemented as a set of instructions (e.g., an application) stored in the storage device 150, and the modules in FIG. 2 may execute the set of instructions and may accordingly be directed to perform the process 300.

In 310, the processing device 112 (e.g., the environment graph determination module 210) may determine an environment graph of an automated guided vehicle (AGV) by preprocessing an AGV scene map.

The processing device 112 may obtain an AGV scene map where the AGV is located. The processing device 112 may process the AGV scene map to determine the environment graph. In some embodiments, the processing device 112 may obtain the AGV scene map from the storage device 150. In some embodiments, the AGV scene map may be determined based on images shot by a shooting device. The processing device 112 may update the AGV scene map periodically or in real-time.

The AGV scene map may include multiple nodes and multiple edges connected to the multiple nodes. The processing device 112 may determine the environment graph by assigning attributes of each node and edge in the AGV scene map. Thus, in the environment graph, each node or edge may include its corresponding attribute associated with the AGV.

As used herein, a node refers to a key location in a path planning scenario for the AGV, such as a warehouse, a shelf, a storage area, a restricted area, an operation area, etc., or any other specific location specified by an operator of the transport system 100. An attribute of a node may include a first constraint on passability of the node and a second constraint on an angle at which the AGV or a load of the AGV is allowed to pass. Specifically, the first constraint on passability of the node may include a constraint on AGVs and a constraint on loads of the AGVs. The constraint on AGVs of the node refers that the node does not allow a certain AGV (e.g., a certain type of AGV, or a designated AGV) to pass through. The constraint on loads of the AGVs of the node refers that when a load of an AGV exceeds a preset weight/volume or the load is a certain load that is not allowed to pass through, the load can not be allowed to pass through the node.

An edge refers to a path between two adjacent nodes. An attribute of an edge may include a third constraint on connectivity of the edge, a fourth constraint on passability of the edge, and a fifth constraint on an angle at which the AGV or the load of the AGV is allowed to pass. Specifically, the third constraint on connectivity of the edge may include a one-way traffic that allows the AGV to pass through the edge in one direction (e.g., from a first node to a second node) or two-way traffic that allows the AGV to pass through the edge in two directions ((i.e., from the first node to the second node, or from the second node to the first node). The fourth constraint on passability of the edge may also include a constraint on AGVs and a constraint on loads of the AGVs. The constraint on AGVs of the edge refers that the edge does not allow a certain AGV to pass through. The constraint on loads of the AGVs of the edge refers that when a load of an AGV exceeds a preset weight/volume or the load is a certain load that is not allowed to pass through, the load can not be allowed to pass through the edge.

In some embodiments, the second constraint of the node or the fifth constraint of the edge may be preset by a user or operator via the terminal device 140. In some embodiments, the second constraint of the node or the fifth constraint of the edge may be determined based on information of the AGV and/or the load of the AGV. In some embodiments, the information of the AGV may include a type, a size, a weight, a volume, etc., of the AGV. The processing device 112 may determine a rotation angle that allows the AGV and/or the load of the AGV to rotate based on the information of the AGV and/or the load of the AGV. For example, for the fifth constraint of the edge, the processing device 112 may obtain a width of the edge. Since the AGV and/or the load can only rotate within a range constrained by the width of the edge, the processing device 112 may determine the rotation angle of the AGV and/or the load based on the width of the edge and the size of the AGV and/or the load according to automotive kinematics.

In 320, the processing device 112 (e.g., the path generation module 220) may determine whether the environment graph of the AGV satisfies a first preset condition.

The first preset condition may include that the AGV can reach an ending point from a starting point in the environment graph. In some embodiments, the processing device 112 may determine whether the environment graph of the AGV satisfies the first preset condition by performing an initial path planning. Specifically, the processing device 112 may obtain the starting point and the ending point, e.g., via the terminal device 140. The processing device 112 may perform the initial path planning for the AGV based on the starting point and the ending point in the environment graph. Specifically, during the initial path planning, the attributes of the nodes, the attributes of the edges, and other AGVs and/or loads (also referred to as interfering AGV and/or interfering loads) may be taken into account.

In response to a failure of the initial path planning, the processing device 112 may determine that the first preset condition is not satisfied. As used herein, the failure of a path planning (e.g., the initial path planning) refers that there is no driving path that allows the AGV to reach the ending point from the starting point in the current environment graph. Correspondingly, the success of a path planning (e.g., the initial path planning) refers that there is at least one driving path that allows the AGV to reach the ending point from the starting point.

In response to a determination that the environment graph does not satisfy the first preset condition, the processing device 112 may proceed to perform operation 330. In response to a determination that the environment graph satisfies the first preset condition, the processing device 112 may proceed to perform operation 360.

In 330, the processing device 112 (e.g., the path generation module 220) may determine an adjustment of the environment graph by performing a path planning for the AGV.

In some embodiments, the adjustment of the environment graph may include an adjustment position and/or an adjustment aspect. Specifically, the adjustment position may indicate which node or edge in the environment graph needs to be adjusted. The adjustment aspect may indicate which aspect of the environment graph needs to be adjusted. For example, if a node needs to be adjusted, the adjustment aspect of the environment graph may indicate the first constraint or the second constraint needs to be adjusted. As another example, if an edge needs to be adjusted, the adjustment aspect of the environment graph may indicate the third constraint, the fourth constraint, or the fifth constraint needs to be adjusted. As a further example, if a node or edge needs to be adjusted, the adjustment aspect of the environment graph may indicate where a new node or edge needs to be added.

In some embodiments, the path planning for the AGV may be performed based on a path planning algorithm. Exemplary path planning algorithms may include an A* (A-star) algorithm, a Floyd algorithm, a Dijkstra algorithm, a Bellman-Ford algorithm, a shortest path faster algorithm (SPFA), etc.

During the path planning, a portion of constraints of the environment graph may be ignored. As used herein, a constraint of the environment graph refers to any factor that may cause the path planning failure. In some embodiments, the constraints of the environment graph may be related to the attributes of the multiple nodes and/or the multiple edges in the environment graph, an interfering AGV, an interfering load, etc.

The processing device 112 may determine the adjustment of the environment graph based on a result of the path planning. Merely by way of example, the path planning may include a preliminary path planning. The portion of constraints of the environment graph in the preliminary path planning may be related to an interfering AGV and an interfering load. That is to say, during the preliminary path planning, constraints on interfering AGVs or interfering loads in the environment graph may be ignored. In other words, compared to the initial path planning, only the attributes of the nodes and the attributes of the edges may be taken into account during the preliminary path planning.

In response to a success of the preliminary path planning, the processing device 112 may determine that there is an interfering AGV or interfering load in the environment graph. That is to say, the presence of the interfering AGV or interfering load leads to the failure of the initial path planning. The adjustment of the environment graph may relate to removing the interfering AGV or interfering load.

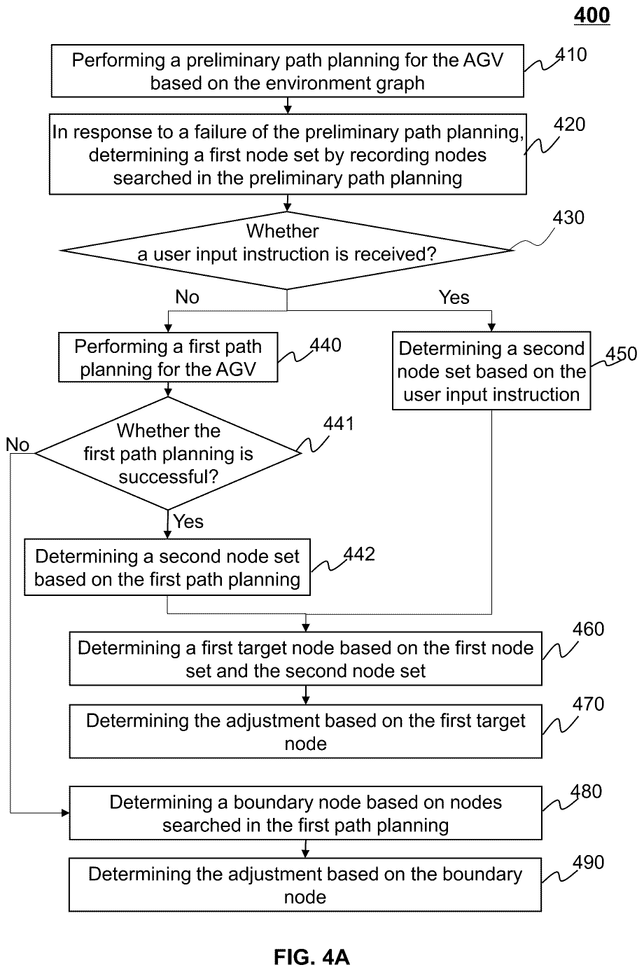

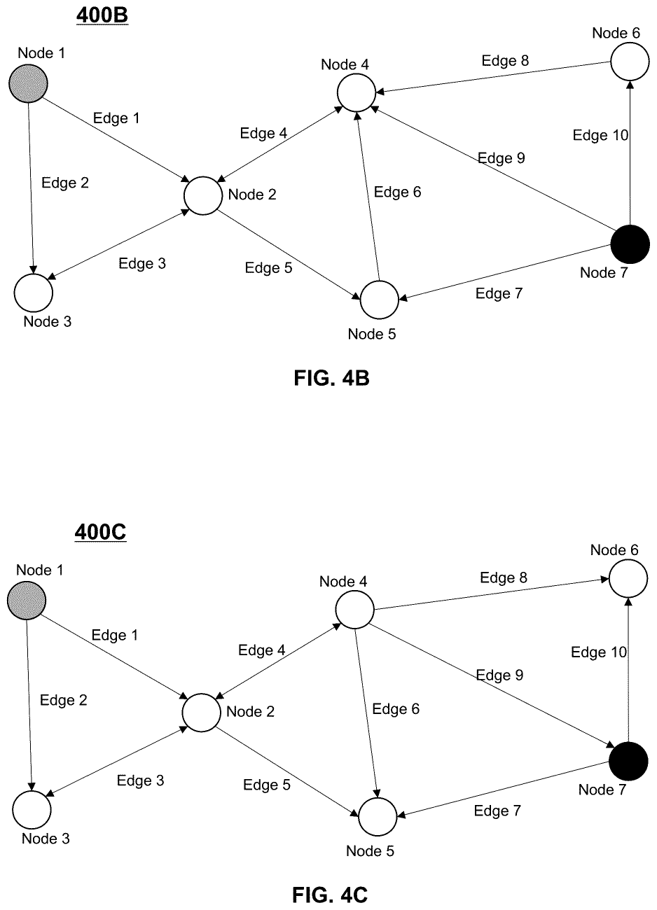

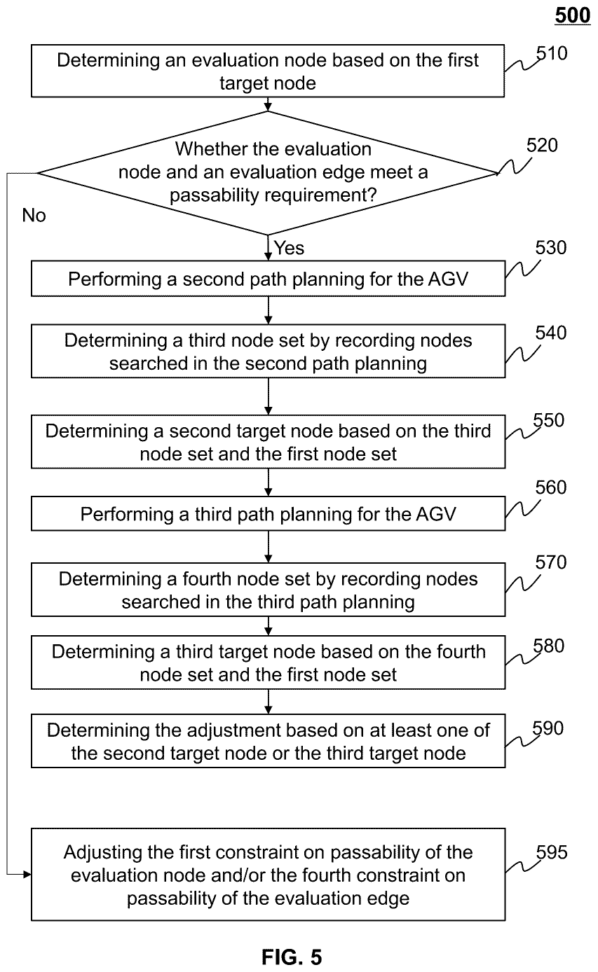

In response to a failure of the preliminary path planning, the processing device 112 may determine that there is an issue with the configuration of the current environment graph. That is to say, the configuration of the current environment graph leads to the failure of the initial path planning. The processing device 112 may further determine, by performing a first path planning and/or a second path planning for the AGV, a target node and a target edge connected to the target node as adjustment positions. For the first path planning, constraints on passability and angles of the multiple nodes and the multiple edges in the environment graph are ignored. The constraints on passability of the multiple nodes and the multiple edges include constraints on load, and for the second path planning, the constraints on load is ignored. More descriptions for determining the adjustment of the environment graph may be found in FIG. 4A or FIG. 5 and the descriptions thereof.

In 340, the processing device 112 (e.g., the path generation module 220) may perform a troubleshooting operation by controlling the transport system (e.g., the transport system 100) based on the adjustment of the environment graph.

In some embodiments, if the adjustment of the environment graph is to adjust the passability of a node/edge, the troubleshooting operation may include changing one or more attributes of the node/edge. For example, the processing device 112 may change a first type of AGV to a second type of AGV for the node/edge. As another example, the processing device 112 may increase the preset weight/volume of the load for the node/edge.

In some embodiments, if the adjustment of the environment graph is to adjust the connectivity of an edge, the processing device 112 may add an additional edge for the node connecting to the edge or change the connectivity of the edge.

In some embodiments, if the adjustment of the environment graph relates to removing the interfering AGV or interfering load, the processing device 112 may communicate with the interfering AGV or interfering load. The processing device 112 may control the interfering AGV or interfering load to move to a certain position designated by the operator or determined by performing a path planning for the interfering AGV or interfering load.

In some embodiments, the processing device 112 may also send a message to the operator of the transport system 100. Upon the operator receiving the message, the operator may perform the troubleshooting operation manually.

In 350, the processing device 112 (e.g., the path generation module 220) may update the environment graph based on a result of the troubleshooting operation.

After the environment graph is updated, the processing device 112 may return to operation 320 to determine whether the updated environment graph of the AGV satisfies the first preset condition.

Further, in response to a determination that the updated environment graph does not satisfy the first preset condition, the processing device 112 may proceed to perform operation 330 to determine an adjustment of the updated environment graph by performing a path planning for the AGV. The processing device 112 may perform an updated troubleshooting operation by controlling the transport system based on the adjustment of the updated environment graph. The processing device 112 may still update the updated environment graph based on a result of the updated troubleshooting operation until the updated environment graph satisfies the first preset condition. In other words, the processing device 112 may perform at least one environmental adjustment.

In 360, in response to the environment graph satisfying the first preset condition, the processing device 112 (e.g., the path generation module 220) may determine a driving path of the AGV based on the environment graph.

The driving path may includes a plurality of nodes and edges arranged in an order in which the AGV can pass through sequentially. Following the driving path, the AGV may successfully reach the ending point from the starting point.

In some embodiments, the driving path may be determined by performing a path planning using a path planning algorithm. In some embodiments, the operator of the transport system 100 may designate the driving path manually. For example, the operator may input the driving path via the terminal device 140.

In 370, the processing device 112 (e.g., the control module 230) may control the AGV to drive along the driving path.

According to some embodiments of the present disclosure, during the controlling process of the AGV, when determining the adjustment of the environment graph, by ignoring a portion of constraints of the environment graph to performing the path planning for the AGV (e.g., by performing the preliminary path planning, or the first path planning and/or a second path planning), the reason that leads to the failure of the initial path planning can be determined intelligently and quickly, thereby improving the efficiency of troubleshooting operations and saving labor costs.

FIG. 4A is a flowchart illustrating an exemplary process for determining an adjustment of an environment graph according to some embodiments of the present disclosure. In some embodiments, process 400 may be performed to achieve at least part of operation 330 as described in connection with FIG. 3.

In 410, the processing device 112 (e.g., the path generation module 220) may perform a preliminary path planning for the AGV based on the environment graph. Constraints on interfering AGVs and interfering loads in the environment graph may be ignored. More descriptions of the preliminary path planning may be found in operation 330 or FIG. 3 and the descriptions thereof.

According to some embodiments of the present disclosure, during the preliminary path planning, by ignoring the constraints on interfering AGVs and interfering loads in the environment graph to performing the preliminary path planning for the AGV, whether the interfering AGVs and/or interfering loads are the cause of the failure of the initial path planning can be determined intelligently and quickly, thereby improving the efficiency of troubleshooting operations and saving labor costs.

In 420, in response to a failure of the preliminary path planning, the processing device 112 (e.g., the path generation module 220) may determine a first node set by recording nodes searched in the preliminary path planning.

In some embodiments, for the convenience of subsequent calculations, the nodes in the first node set may be stored orderly. For example, the nodes in the first node set may be stored in search order. In some embodiments, the nodes in the first node set may form and be stored as a first incomplete path beginning from the starting point of the AGV. The first incomplete path may have a length (i.e., a count of nodes of the first incomplete path).

In 430, the processing device 112 (e.g., the path generation module 220) may determine whether a user input instruction is received.

The user input instruction may include information of a designed driving path from the starting point to the ending point.

In response to a determination that the user input instruction is not received, the processing device 112 may proceed to perform operation 440. In response to a determination that the user input instruction is received, the processing device 112 may proceed to perform operation 450.

In 440, the processing device 112 (e.g., the path generation module 220) may perform a first path planning for the AGV.

During the first path planning, constraints on passability and angles of the multiple nodes and the multiple edges in the environment graph are ignored. In other words, only the connectivity of the edges in the environment graph are taken into account during the first path planning.

In 441, the processing device 112 (e.g., the path generation module 220) may determine whether the first path planning is successful.

In response to a determination that the first path planning is successful, the processing device 112 may determine that the connectivity of the multiple edges in the current environment graph is not the failure reason of the preliminary path planning, and the processing device 112 may proceed to perform operation 442. In response to a determination that the first path planning is failed, the processing device 112 may determine that the connectivity of the multiple edges in the current environment graph is the failure reason of the preliminary path planning, and the processing device 112 may proceed to perform operation 480.

In 442, the processing device 112 (e.g., the path generation module 220) may determine a second node set based on the first path planning.

The second node set may include nodes searched in the first path planning. Similar to the first node set, the nodes in the second node set may also be stored orderly. For example, the nodes in the second node set may be stored in search order. In some embodiments, the nodes in the second node set may also form and be stored as a second incomplete path beginning from the starting point of the AGV. The second incomplete path may have a length (i.e., a count of nodes of the second incomplete path).

In 450, the processing device 112 (e.g., the path generation module 220) may determine a second node set based the user input instruction.

In some embodiments, the user (e.g., an operator) may input nodes and edges in an order in which the AGV can pass through sequentially. The input nodes and edges may be stored sequentially to form the second node set.

In 460, the processing device 112 (e.g., the path generation module 220) may determine a first target node based on the first node set and the second node set.

As used herein, the first target node refers to a node in the second node set that is the first one node different from the nodes in the first node set. Specifically, the processing device 112 may sequentially research for each node of the second node set in the first node set. In response to a certain node in the second node set can not be found in the first node set, the processing device 112 may determine the certain node as the first target node.

In some embodiments, in order to reduce computational amount, the processing device 112 may determine a node set similarity based on the first node set and the second node set. In response to the node set similarity not being 1, the processing device 112 may determine the first target node by a first preset algorithm.

Specifically, the processing device 112 may select a target incomplete path with the shortest length from the first node set or the second node set. The processing device 112 may truncate the node set that do not contain the target incomplete path. The processing device 112 may construct a first matching vector based on the truncated node set, and a second matching vector based on the node set contain the target incomplete path. For example, if the target incomplete path is selected from the first node set, the processing device 112 may truncate the second node set to construct a truncated second node set with the same length as the target incomplete path. The processing device 112 may further determine the first matching vector based on the truncated second node set, and the second matching vector based on the first node set. As another example, the first node set is denoted as (1, 2, 3, 4, 5, 6, 7) and the second node set is denoted as (1, 2, 3, 5). The processing device 112 may truncate the first node set based on the length of the incomplete path in the second node set. Thus, the processing device 112 may retain the first four nodes in the first node set in order, i.e., the truncated first node set may be determined as (1, 2, 3, 4). The processing device 112 may determine the first matching vector based on (1, 2, 3, 4), and determine the second matching vector based on (1, 2, 3, 5).

The processing device 112 may determine a vector similarity between the the first matching vector and the second matching vector as the node set similarity. In some embodiments, in response to the node set similarity not being 1, the processing device 112 may determine the first target node by a first preset algorithm. Specifically, the processing device 112 may perform string matching between the truncated node set and the node set containing the target incomplete path to identify the first mismatched character. The processing device 112 may determine the first mismatched character as the first target node. Exemplary first preset algorithms may include a Knuth-Morris-Pratt (KMP) algorithm, a search algorithm, a Rabin-Karp Hash algorithm, a Brute-Force algorithm, etc.

According to some embodiments of the present disclosure, by determining the first target node through the node set similarly, the computational amount can be reduced.

In 470, the processing device 112 (e.g., the path generation module 220) may determine the adjustment of the environment graph based on the first target node.

The processing device 112 may determine an evaluation node based on the first target node. In response to the evaluation node or an evaluation edge connecting to the evaluation node and the first target node not meeting a passability requirement, the processing device 112 may adjust the first constraint on passability of the evaluation node or the fourth constraint on passability of the evaluation edge. For example, the processing device 112 may change the types of AGVs or loads in the attributes of the evaluation node and/or the evaluation edge.

In response to the evaluation node and the evaluation edge connecting to the evaluation node and the first target node meeting the passability requirement, the processing device 112 may perform a second path planning for the AGV. During the second path planning, constraints on passability of the multiple nodes and the multiple edges include constraints on load, and the constraints on load is ignored in the second path planning. The processing device 112 may determine a third node set by recording nodes searched in the second path planning. The processing device 112 may determine a second target node based on the third node set and the first node set. The processing device 112 may determine the adjustment of the environment graph based on the second target node. More descriptions for determining the adjustment of the environment graph based on the first target node may be found in FIG. 5 and the descriptions thereof.

In 480, the processing device 112 (e.g., the path generation module 220) may determine a boundary node based on nodes searched in the first path planning.

As used herein, the boundary node refers to a node in the environment graph that has incoming edges and no outgoing edges. As shown in FIG. 4B, FIG. 4B is a schematic diagram illustrating an exemplary environment graph according to some embodiments of the present disclosure. The environment graph 400B may include seven nodes and ten edges connected between two adjacent nodes, wherein node 1 is the starting point and node 7 is the ending point. The connectivity of each edge is indicated by an arrow. During the first path planning, when the processing device 112 searches to node 4, the the processing device 112 may recognize that node 4 has incoming edges 4, 6, 8, and 9, and no outgoing edges. Thus, the processing device 112 may determine node 4 as the boundary node.

In some embodiments, the processing device 112 may obtain an adjacency matrix of the multiple nodes in the environment graph. For example, the processing device 112 may obtain the adjacency matrix of the multiple nodes from the storage device 150. The processing device 112 may determine the boundary node based on the adjacency matrix and the nodes searched in the first path planning. As used herein, the adjacency matrix may be a two-dimensional array storing information of the environment graph. The processing device 112 may calculate a row (column) where an out-degree of each searched node in the first node set and a column (row) where an in-degree of each searched node in the first node set. If a row where the out-degree of a specific node is 0, and a column where the in-degree of the specific node is not 0, the specific node may be determined as the boundary node, otherwise, the specific node can not be determined as the boundary node.

Merely by way of example, a portion of an exemplary environment graph including four searched nodes v₀, v₁, v₂, and v₃ in the first path planning may be expressed as an adjacency matrix as follows:

$$\begin{matrix}{v}_{0} \\ {v}_{1} \\ {v}_{2} \\ {v}_{3}\end{matrix} [ \begin{matrix}{v}_{0} & {v}_{1} & {v}_{2} & {v}_{3} \\ 0 & 1 & 0 & 1 \\ 1 & 0 & 1 & 0 \\ 1 & 1 & 0 & 0 \\ 0 & 0 & 0 & 0\end{matrix} ]$$

For the searched node v₁ in the first path planning, since a sum of the row where the searched node v₁ is located is 2, the processing device 112 may determine that the searched node v₁ is not a boundary node. For the searched node v₃ in the first path planning, since a sum of the row where the searched node v₃ is located is 0, the processing device 112 may determine that that the searched node v₃ is a boundary node.

According to some embodiments of the present disclosure, by automatically determining the boundary node based on the adjacency matrix of the multiple nodes, the execution efficiency and efficiency of the environmental adjustment can be improved.

In 490, the processing device 112 (e.g., the path generation module 220) may determine the adjustment of the environment graph based on the boundary node.

The processing device 112 may determine one or more target edges connected to the boundary node as adjustment positions in the current environment graph. The processing device 112 may change or add the connectivity of the one or more target edges to update the current environment graph. As shown in FIG. 4C, FIG. 4C is a schematic diagram illustrating an exemplary updated environment graph by updating the environment graph in FIG. 4B. Compared to FIG. 4B, edges 6, 8, and 9 in FIG. 4C are the target edges connected to the boundary node 4. The connectivity of the target edges 6, 8, and 9 are changed (or reversed). As a result, node 5 can be determined as an updated boundary node during the next path planning. The processing device 112 may process the updated boundary node in a similar manner to processing the boundary node until it is determined that any boundary node cannot be detected.

In some embodiments, the processing device 112 may remind the user to know the boundary node, e.g., via a voice, a text, etc. The user may determine the adjustment and update the environment graph via the terminal device 140.

More descriptions regarding the adjustment of the environment graph may be found elsewhere in the present disclosure, e.g., operations 310-350 in FIG. 3 and the descriptions thereof.

According to some embodiments of the present disclosure, after determining that the preliminary path planning is failed, if a user designates a driving path from the starting point to the ending point (i.e., a user input instruction is received), the first target node can be determined quickly, thereby improving the speed of determining the adjustment of the environment graph.

Alternatively, after determining that the preliminary path planning is failed, if a user input instruction is not received, by performing the first path planning for the AGV during which constraints on passability and angles of the multiple nodes and the multiple edges in the environment graph are ignored, whether the connectivity of the multiple edges is the cause of the failure of the preliminary path planning can be determined intelligently and quickly, thereby improving the efficiency of troubleshooting operations and saving labor costs.

FIG. 5 is a flowchart illustrating an exemplary process for determining an adjustment of an environment graph according to some embodiments of the present disclosure. In some embodiments, process 500 may be performed to achieve at least part of operation 470 as described in connection with FIG. 4A.

In 510, the processing device 112 (e.g., the path generation module 220) may determine an evaluation node based on the first target node.

The evaluation node refers to a node next to the first target node in the second node set.

In 520, the processing device 112 (e.g., the path generation module 220) may determine whether the evaluation node or an evaluation edge connecting the evaluation node and the first target node meet a passability requirement.

The passability requirement may include that the evaluation node or the evaluation edge allows a certain AGV (e.g., a certain type of AGV, or a designated AGV) or a certain load (e.g., a certain type of load, or a designated load) to pass through, or allows a load with a weight/volume less than a weight/volume threshold.

In response to the evaluation node and/or the evaluation edge not meeting the passability requirement, i.e., the attribute of the evaluation node and/or the evaluation edge does not allow the AGV and the load of the AGV to pass through, the processing device 112 may proceed to perform operation 595 to adjust the first constraint on passability of the evaluation node or the fourth constraint on passability of the evaluation edge. In response to the evaluation node and the evaluation edge meeting the passability requirement, the processing device 112 may proceed to perform operation 530.

In 530, the processing device 112 (e.g., the path generation module 220) may perform a second path planning for the AGV.

During the second path planning, constraints on passability of the multiple nodes and the multiple edges include constraints on load. As used herein, the constraints on load of the multiple nodes and the multiple edges may indicate that when the load of the AGV exceeds a preset weight/volume or the load is a certain load that is not allowed to pass through, the load can not be allowed to pass through the multiple nodes and the multiple edges. The constraints on load are ignored in the second path planning.

In 540, the processing device 112 (e.g., the path generation module 220) may determine a third node set by recording nodes searched in the second path planning.

The configuration of the third node set may be similar to the configuration of the first node set or the second node set. For example, for the convenience of subsequent calculations, the nodes in the third node set may be stored in search order. As another example, the nodes in the third node set may form and be stored as a third incomplete path beginning from the starting point of the AGV. The third incomplete path may have a length (i.e., a count of nodes of the third incomplete path).

In 550, the processing device 112 (e.g., the path generation module 220) may determine a second target node based on the third node set and the first node set.

The determination manner of the second target node may be similar to that of the first target node, which is not repeated here.

In 560, the processing device 112 (e.g., the path generation module 220) may perform a third path planning for the AGV.

During the third path planning, the constraints on passability of the multiple nodes and the multiple edges include constraints on equipment. As used herein, the constraints on equipment of the multiple nodes and the multiple edges may indicate that the multiple nodes and the multiple edges do not allow a certain AGV (e.g., a certain type of AGV, or a designated AGV) to pass through. The constraints on equipment is ignored in the third path planning.

In 570, the processing device 112 (e.g., the path generation module 220) may determine a fourth node set by recording nodes searched in the third path planning.

The configuration of the fourth node set may be similar to the configuration of the first node set, the second node set, or the third node set. For example, for the convenience of subsequent calculations, the nodes in the fourth node set may be stored in search order. As another example, the nodes in the fourth node set may form and be stored as a fourth incomplete path beginning from the starting point of the AGV. The fourth incomplete path may have a length (i.e., a count of nodes of the fourth incomplete path).

In 580, the processing device 112 (e.g., the path generation module 220) may determine a third target node based on the fourth node set and the first node set.

The determination manner of the third target node may be similar to that of the first target node, which is not repeated here.

In 590, the processing device 112 (e.g., the path generation module 220) may determine the adjustment of the environment graph based on at least one of the second target node and the third target node.

In some embodiments, the processing device 112 may determine the second target node and/or the third target node as the adjustment position. Further, the processing device 112 may adjust an angle attribute (i.e., an angle at which the AGV or a load of the AGV is allowed to pass) of the second target node and/or the third target node. For example, the processing device 112 may first determine the second target node as the adjustment position. The processing device 112 may adjust an angle attribute of the second target node (i.e., an angle at which the AGV or a load of the AGV is allowed to pass) and update the second target node until the second path planning is successful. Then, in response to a failure of the third path planning, the processing device 112 may also determine the third target node as the adjustment position. The processing device 112 may adjust an angle attribute (i.e., an angle at which the AGV or a load of the AGV is allowed to pass) of the third target node.

It should be noted that when the second path planning is successful, the processing device 112 may only determine the third target node, that is, operations 530-550 are omitted and the second target node does not exist. In such cases, the processing device 112 may determine the adjustment of the environment graph based on the third target node. Therefore, by performing the third path planning for the AGV during which constraints on equipment of the multiple nodes and the multiple edges in the environment graph are ignored, whether the equipment of the multiple nodes and the multiple edges is the cause of the failure of the preliminary path planning can be determined intelligently and quickly, thereby improving the efficiency of troubleshooting operations and saving labor costs.

Similarly, in some embodiments, when the third path planning is successful, the processing device 112 may only determine the second target node, that is, operations 560-580 are omitted and the third target node does not exist. In such cases, the processing device 112 may determine the adjustment of the environment graph based on the second target node. Therefore, by performing the second path planning for the AGV during which constraints on load of the multiple nodes and the multiple edges in the environment graph are ignored, whether the load of the multiple nodes and the multiple edges is the cause of the failure of the preliminary path planning can be determined intelligently and quickly, thereby improving the efficiency of troubleshooting operations and saving labor costs.

In some embodiments, the processing device 112 may determine a rotation evaluation node based on the second target node or third target node. The processing device 112 may determine the adjustment of the environment graph based on the rotation evaluation node.

In some embodiments, for the second target node, the processing device 112 may determine a node next to the second target node in the third node set as the rotation evaluation node. In some embodiments, for the third target node, the processing device 112 may determine a node next to the third target node in the fourth node set as the rotation evaluation node. The processing device 112 may determine whether the second target node (or the third target node) allows the AGV to rotate to reach the rotation evaluation node.

In response to a determination that the second target node (or the third target node) not allows the AGV to rotate to reach the rotation evaluation node, the processing device 112 may determine the second target node (or the third target node) and the rotation evaluation node as the adjustment position. That is to say, the actual working scenario of the AGV not allows the AGV to rotate to reach the rotation evaluation node. Correspondingly, the processing device 112 may determine whether to add additional nodes that can allow the AGV to rotate to reach the rotation evaluation node.

In response to a determination that the second target node (or the third target node) allows the AGV to rotate to reach the rotation evaluation node, the processing device 112 may determine the second target node (or the third target node) as the adjustment position. That is to say, the actual working scenario of the AGV allows the AGV to rotate to reach the rotation evaluation node, but the environment graph has some wrong information that leads the AGV can not rotate to reach the rotation evaluation node. Correspondingly, the processing device 112 may adjust the angle attribute of the second target node (or the third target node). For example, the processing device 112 may increase the angle in the attribute of the second target node (or the third target node).

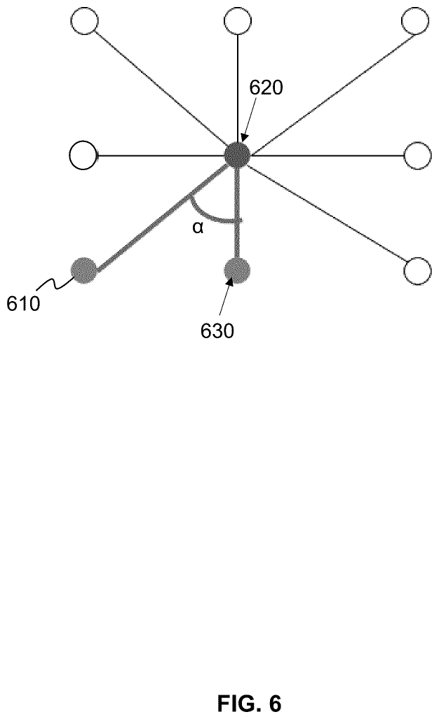

FIG. 6 is a schematic diagram illustrating a portion of an exemplary environment graph. Merely by way of example, as shown in FIG. 6, the processing device 112 may determine an angle α forming by the second target node 610 (or the third target node), the rotation evaluation node 620, and the next node 630 of the rotation evaluation node 620. The processing device 112 may determine whether the angle α is less than or equal to the angle in the angle attribute of the rotation evaluation node 620. In response to a determination that the angle α is less than or equal to the angle in the angle attribute of the rotation evaluation node 620, the processing device 112 may determine that the second target node (or the third target node) allows the AGV to rotate to reach the rotation evaluation node. In response to a determination that the angle α is greater than the angle in the angle attribute of the rotation evaluation node 620, the processing device 112 may determine that the second target node (or the third target node) not allows the AGV to rotate to reach the rotation evaluation node.

According to some embodiments of the present disclosure, after determining that the interfering AGV, the interfering load, the passability of the multiple nodes, the passability and the connectivity of the multiple edges are not the reason for the failure of the preliminary path planning, the processing device 112 may determine that the reason for the failure of the preliminary path planning may be related the angle in the attributes of the multiple node or edges. By considering the overall rotation of a possible driving path (e.g., a possible driving path forming by nodes 610, 620, 630 and edges therebetween as shown in FIG. 6) makes it more specific for determining the adjustment aspect, thereby reducing the workload of the subsequent troubleshooting operations.

In some embodiments, the adjustment may be related to one or more equipment parameters of the AGV. The processing device 112 may determine the adjustment of the environment graph based on the rotation evaluation node and the one or more equipment parameters of the AGV.

In some embodiments, the one or more equipment parameters of the AGV may include the length, width, height, a rated load capacity, etc., of the AGV. The processing device 112 may determine the adjustment (e.g., the adjustment aspect) by performing a vector matching based on the rotation evaluation node and the one or more equipment parameters of the AGV. For example, the processing device 112 may predetermine a standard vector. Specifically, the processing device 112 may construct clustering vectors based on at least one historical rotation evaluation node in a historical database, historical equipment parameters of AGVs, and historical adjustment aspects corresponding to the at least one historical rotation evaluation node in the historical database to form a preset count of cluster centers. The processing device 112 may determine each cluster center corresponding to the at least one historical rotation evaluation node in the historical database and the historical equipment parameters of AGVs as the standard vector, and determine the corresponding historical adjustment aspect as a label of the standard vector. It should be noted that the historical adjustment aspects corresponding to the at least one historical rotation evaluation node in the historical database may be determined by on-site investigation by an operator. For a historical rotation evaluation node and historical equipment parameters of a historical AGV, the operator may adjust the load of the historical AGV, e.g., replacing another type of load. After the load adjustment, if the historical AGV can rotate to reach the rotation evaluation node, the processing device 112 may determine that the corresponding historical adjustment aspect is the load of the historical AGV. Otherwise, the processing device 112 may determine that the corresponding historical adjustment aspect is the historical AGV.

The processing device 112 may construct a vector to be matched based on the current rotation evaluation node and the parameters of the AGV. The processing device 112 may determine a vector similarity between the vector to be matched and the standard vector, and select the label corresponding to the standard vector with the highest vector similarity as the adjustment of the environment graph.

According to some embodiments of the present disclosure, by considering the one or more equipment parameters of the AGV (i.e., considering the AGV (e.g, the AGV type, the AGV size, etc.), the adjustment of the environment graph can also be well determined when the AGV is updated and/or replaced, thereby making the determination results more realistic.

In some embodiments, the processing device 112 may determine a rotation angle feature based on the one or more equipment parameters of the AGV. The processing device 112 may determine the adjustment (e.g., the adjustment aspect) based on the rotation evaluation node and the rotation angle feature. The rotation angle feature of the AGV may include an angle that indicates a difference between the rotation of a mass point and the rotation of the AGV. In some embodiments, the processing device 112 may determine the rotation angle feature by retrieving a predetermined table according to the one or more equipment parameters of the AGV. Specifically, the predetermined table may include a plurality of AGVs and the corresponding rotation angle feature. The processing device 112 may query the predetermined table based on the one or more equipment parameters of the AGV to determine the rotation angle feature.

Merely by way of example, the AGV is required to rotate by 80° at the rotation evaluation node, the rotation angle feature of the AGV is 15°, and the angle in the attributes of the rotation evaluation node is 90°. That is to say, if the rotation angle feature of the AGV is not considered, the AGV can theoretically rotate to reach the rotation evaluation node. However, since the presence of the rotation angle feature of the AGV, the AGV actually requires a rotation range of at least 95°. In such cases, the AGV can not rotate to reach the rotation evaluation node. The processing device 112 may determine that the adjustment aspect is the AGV. Otherwise, the processing device 112 may determine that the adjustment aspect is the load.

According to some embodiments of the present disclosure, starting from the actual rotation angle of the AGV, by further considering the rotation angle feature, it can make determining the rotation angle of the AGV more targeted, resulting in a more accurate result.

In some embodiments, the processing device 112 may determine the adjustment (e.g., the adjustment aspect) based on an adjustment determination model. The processing device 112 may input the rotation evaluation node and the rotation angle feature into the adjustment determination model to determine the adjustment aspect corresponding to the rotation evaluation node and the rotation angle feature. The adjustment determination model may be trained using a plurality of training samples. Each of the plurality of training samples may comprise a sample rotation evaluation node, a sample rotation angle feature, and a sample adjustment aspect corresponding to the sample rotation evaluation node and the sample rotation angle feature, and during the training, the corresponding sample adjustment aspect may be used as a label. By adopting the adjustment determination model, feature connections among data (e.g., information of the rotation evaluation node, the rotation angle feature, and the adjustment aspect) can be obtained more conveniently and efficiently, and the determined adjustment aspect can be more accurate.

In 595, the processing device 112 (e.g., the path generation module 220) may adjust the first constraint on passability of the evaluation node or the fourth constraint on passability of the evaluation edge.

More descriptions regarding the adjustment of the environment graph may be found elsewhere in the present disclosure, e.g., operations 310-350 in FIG. 3 and operations 410-490 in FIG. 4A and the descriptions thereof.

The operations of the illustrated processes 300 to 500 presented above are intended to be illustrative. In some embodiments, a process may be accomplished with one or more additional operations not described, and/or without one or more of the operations discussed. Additionally, the order in which the operations of a process described above is not intended to be limiting.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer-readable media having computer-readable program code embodied thereon.

A non-transitory computer-readable signal medium may include a propagated data signal with computer readable program code embodied therein, for example, in baseband or as part of a carrier wave. Such a propagated signal may take any of a variety of forms, including electromagnetic, optical, or the like, or any suitable combination thereof. A computer-readable signal medium may be any computer-readable medium that is not a computer-readable storage medium and that may communicate, propagate, or transport a program for use by or in connection with an instruction execution system, apparatus, or device. Program code embodied on a computer-readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object-oriented programming language such as Java, Scala, Smalltalk, Eiffel, JADE, Emerald, C++, C#, VB. NET, Python or the like, conventional procedural programming languages, such as the “C” programming language, Visual Basic, Fortran, Perl, COBOL, PHP, ABAP, dynamic programming languages such as Python, Ruby, and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (Saas).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution, e.g., an installation on an existing server or mobile device.

Similarly, it should be appreciated that in the foregoing description of embodiments of the present disclosure, various features are sometimes grouped together in a single embodiment, figure, or description thereof to streamline the disclosure aiding in the understanding of one or more of the various inventive embodiments. This method of disclosure, however, is not to be interpreted as reflecting an intention that the claimed object matter requires more features than are expressly recited in each claim. Rather, inventive embodiments lie in less than all features of a single foregoing disclosed embodiment.

In some embodiments, the numbers expressing quantities, properties, and so forth, used to describe and claim certain embodiments of the application are to be understood as being modified in some instances by the term “about,” “approximate,” or “substantially.” For example, “about,” “approximate” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

What is claimed is:

1. A method for controlling an automated guided vehicle (AGV), implemented on a computing device having at least one processor and at least one storage device, the method comprising:
determining an environment graph of the AGV by preprocessing an AGV scene map, the AGV scene map including multiple nodes and multiple edges connected to the multiple nodes, wherein an attribute of each node in the environment graph includes a first constraint on passability of the node and a second constraint on an angle at which the AGV or a load of the AGV is allowed to pass, and an attribute of each edge in the environment graph includes a third constraint on connectivity of the edge, a fourth constraint on passability of the edge, and a fifth constraint on an angle at which the AGV or the load of the AGV is allowed to pass; and
in response to the environment graph of the AGV not satisfying a first preset condition, performing at least one environmental adjustment, wherein each environmental adjustment includes:
determining an adjustment of the environment graph by performing a path planning for the AGV, wherein a portion of constraints of the environment graph is ignored in the path planning,
performing a troubleshooting operation by controlling a transport system based on the adjustment of the environment graph, and
updating the environment graph based on a result of the troubleshooting operation; and
in response to the environment graph satisfying the first preset condition,
determining a driving path of the AGV based on the environment graph, and
controlling the AGV to drive along the driving path.

2. The method of claim 1, wherein the each environmental adjustment further includes:
performing a preliminary path planning for the AGV based on the environment graph, wherein constraints on interfering AGVs and interfering loads in the environment graph are ignored; and
in response to a failure of the preliminary path planning, determining a first node set by recording nodes searched in the preliminary path planning.

3. The method of claim 2, wherein the determining the adjustment of the environment graph by performing the path planning for the AGV includes:
in response to receiving a user input instruction, determining a second node set based on the user input instruction;
determining a first target node based on the first node set and the second node set; and
determining the adjustment of the environment graph based on the first target node.

4. The method of claim 2, wherein the determining the adjustment of the environment graph by performing the path planning for the AGV includes:
in response to not receiving a user input instruction, performing a first path planning for the AGV, wherein constraints on passability and angles of the multiple nodes and the multiple edges in the environment graph are ignored in the first path planning;
in response to a success of the first path planning,
determining a second node set based on the first path planning,
determining a first target node based on the first node set and the second node set, and
determining the adjustment of the environment graph based on the first target node; and
in response to a failure of the first path planning,
determining a boundary node based on nodes searched in the first path planning, and
determining the adjustment of the environment graph based on the boundary node.

5. The method of claim 4, wherein the determining the boundary node based on the nodes searched in the first path planning includes:
obtaining an adjacency matrix of the multiple nodes in the environment graph; and
determining the boundary node based on the adjacency matrix and the nodes searched in the first path planning.

6. The method of claim 3, wherein the determining the first target node based on the first node set and the second node set includes:
determining a node set similarity based on the first node set and the second node set; and
in response to the node set similarity not being 1, determining the first target node by a first preset algorithm.

7. The method of claim 3, wherein the determining the adjustment of the environment graph based on the first target node includes:
determining an evaluation node based on the first target node;
in response to the evaluation node or an evaluation edge connecting to the evaluation node and the first target node not meeting a passability requirement, adjusting the first constraint on passability of the evaluation node or the fourth constraint on passability of the evaluation edge; and
in response to the evaluation node and the evaluation edge connecting to the evaluation node and the first target node meeting the passability requirement,
performing a second path planning for the AGV, wherein constraints on passability of the multiple nodes and the multiple edges include constraints on load, the constraints on load is ignored in the second path planning,
determining a third node set by recording nodes searched in the second path planning,
determining a second target node based on the third node set and the first node set, and
determining the adjustment of the environment graph based on the second target node.

8. The method of claim 7, wherein the determining the adjustment of the environment graph based on the second target node includes:
determining a rotation evaluation node based on the second target node; and
determining the adjustment of the environment graph based on the rotation evaluation node.

9. The method of claim 3, wherein the determining the adjustment of the environment graph based on the first target node includes:
determining an evaluation node based on the first target node;
in response to the evaluation node or an evaluation edge connecting to the evaluation node and the first target node not meeting a passability requirement, adjusting the first constraint on passability of the evaluation node or the fourth constraint on passability of the evaluation edge; and
in response to the evaluation node and the evaluation edge connecting the evaluation node and the first target node meeting the passability requirement,
performing a third path planning for the AGV, wherein the constraints on passability of the multiple nodes and the multiple edges include constraints on equipment, the constraints on equipment is ignored in the third path planning,
determining a fourth node set by recording nodes searched in the third path planning,
determining a third target node based on the fourth node set and the first node set, and
determining the adjustment of the environment graph based on the third target node.

10. The method of claim 9, wherein the determining the adjustment of the environment graph based on the third target node includes:
determining a rotation evaluation node based on the third target node; and
determining the adjustment of the environment graph based on the rotation evaluation node.

11. The method of claim 8, wherein the adjustment is related to one or more equipment parameters of the AGV, and the determining the adjustment of the environment graph based on the rotation evaluation node includes:
determining the adjustment of the environment graph based on the rotation evaluation node and the one or more equipment parameters of the AGV.

12. The method of claim 11, wherein the determining the adjustment of the environment graph based on the rotation evaluation node and the one or more equipment parameters of the AGV includes:
determining a rotation angle feature based on the one or more equipment parameters of the AGV; and
determining the adjustment of the environment graph based on the rotation evaluation node and the rotation angle feature.

13. A system, comprising:
at least one storage device storing executable instructions for controlling an automated guided vehicle (AGV); and
at least one processor in communication with the at least one storage device, wherein when executing the executable instructions, the at least one processor is configured to cause the system to perform operations including:
determining an environment graph of the AGV by preprocessing an AGV scene map, the AGV scene map including multiple nodes and multiple edges connected to the multiple nodes, wherein an attribute of each node in the environment graph includes a first constraint on passability of the node and a second constraint on an angle at which the AGV or a load of the AGV is allowed to pass, and an attribute of each edge in the environment graph includes a third constraint on connectivity of the edge, a fourth constraint on passability of the edge, and a fifth constraint on an angle at which the AGV or the load of the AGV is allowed to pass; and
in response to the environment graph of the AGV not satisfying a first preset condition, performing at least one environmental adjustment, wherein each environmental adjustment includes:
determining an adjustment of the environment graph by performing a path planning for the AGV, wherein a portion of constraints of the environment graph is ignored in the path planning,
performing a troubleshooting operation by controlling a transport system based on the adjustment of the environment graph, and
updating the environment graph based on a result of the troubleshooting operation; and
in response to the environment graph satisfying the first preset condition,
determining a driving path of the AGV based on the environment graph, and
controlling the AGV to drive along the driving path.

14. The system of claim 13, wherein the each environmental adjustment further includes:
performing a preliminary path planning for the AGV based on the environment graph, wherein constraints on interfering AGVs and interfering loads in the environment graph are ignored; and
in response to a failure of the preliminary path planning, determining a first node set by recording nodes searched in the preliminary path planning.

15. The system of claim 14, wherein the determining the adjustment of the environment graph by performing the path planning for the AGV includes:
in response to receiving a user input instruction, determining a second node set based on the user input instruction;
determining a first target node based on the first node set and the second node set; and
determining the adjustment of the environment graph based on the first target node.

16. The system of claim 14, wherein the determining the adjustment of the environment graph by performing the path planning for the AGV includes:
in response to not receiving a user input instruction, performing a first path planning for the AGV, wherein constraints on passability and angles of the multiple nodes and the multiple edges in the environment graph are ignored in the first path planning;
in response to a success of the first path planning,
determining a second node set based on the first path planning,
determining a first target node based on the first node set and the second node set, and
determining the adjustment of the environment graph based on the first target node; and
in response to a failure of the first path planning,
determining a boundary node based on nodes searched in the first path planning, and
determining the adjustment of the environment graph based on the boundary node.

17. The system of claim 15, wherein the determining the adjustment of the environment graph based on the first target node includes:
determining an evaluation node based on the first target node;
in response to the evaluation node or an evaluation edge connecting to the evaluation node and the first target node not meeting a passability requirement, adjusting the first constraint on passability of the evaluation node or the fourth constraint on passability of the evaluation edge; and
in response to the evaluation node and the evaluation edge connecting to the evaluation node and the first target node meeting the passability requirement,
performing a second path planning for the AGV, wherein constraints on passability of the multiple nodes and the multiple edges include constraints on load, the constraints on load is ignored in the second path planning,
determining a third node set by recording nodes searched in the second path planning,
determining a second target node based on the third node set and the first node set, and
determining the adjustment of the environment graph based on the second target node.

18. The system of claim 17, wherein the determining the adjustment of the environment graph based on the second target node includes:
determining a rotation evaluation node based on the second target node; and
determining the adjustment of the environment graph based on the rotation evaluation node.

19. The system of claim 15, wherein the determining the adjustment of the environment graph based on the first target node includes:
determining an evaluation node based on the first target node;
in response to the evaluation node or an evaluation edge connecting to the evaluation node and the first target node not meeting a passability requirement, adjusting the first constraint on passability of the evaluation node or the fourth constraint on passability of the evaluation edge; and
in response to the evaluation node and the evaluation edge connecting the evaluation node and the first target node meeting the passability requirement,
performing a third path planning for the AGV, wherein the constraints on passability of the multiple nodes and the multiple edges include constraints on equipment, the constraints on equipment is ignored in the third path planning,
determining a fourth node set by recording nodes searched in the third path planning,
determining a third target node based on the fourth node set and the first node set, and
determining the adjustment of the environment graph based on the third target node.

20. A non-transitory computer readable medium, comprising at least one set of instructions for controlling an automated guided vehicle (AGV), wherein when executed by at least one processor of a computing device, the at least one set of instructions direct the at least one processor to perform operations including:
determining an environment graph of the AGV by preprocessing an AGV scene map, the AGV scene map including multiple nodes and multiple edges connected to the multiple nodes, wherein an attribute of each node in the environment graph includes a first constraint on passability of the node and a second constraint on an angle at which the AGV or a load of the AGV is allowed to pass, and an attribute of each edge in the environment graph includes a third constraint on connectivity of the edge, a fourth constraint on passability of the edge, and a fifth constraint on an angle at which the AGV or the load of the AGV is allowed to pass; and
in response to the environment graph of the AGV not satisfying a first preset condition, performing at least one environmental adjustment, wherein each environmental adjustment includes:
determining an adjustment of the environment graph by performing a path planning for the AGV, wherein a portion of constraints of the environment graph is ignored in the path planning,
performing a troubleshooting operation by controlling a transport system based on the adjustment of the environment graph, and
updating the environment graph based on a result of the troubleshooting operation; and
in response to the environment graph satisfying the first preset condition,
determining a driving path of the AGV based on the environment graph, and
controlling the AGV to drive along the driving path.
